(19) United States
(12) Patent Application Publication
(10) Pub. No.: US 2011/0233829 A1
(43) Pub. Date: Sep. 29, 2011

(54) Process and die for manufacturing a plastic hollow body

(75) Inventors: Bjorn Criel, Sint-martens-lennik (BE); Jean-Claude Mur, Le Plessis Brion (FR); Frederic Jannot, Bousval (BE); Stephane Galliot, Janville (FR); Pierre-Francois Tardy, Brussels (BE)

(73) Assignee: INERGY AUTOMOTIVE SYSTEMS RESEARCH (Societe Anonyme), Brussels (BE)

(21) Appl. No.: 12/671,666

(22) PCT Filed: Aug. 7, 2008
(86) PCT No.: PCT/EP08/60391

§ 371 Date: Feb. 1, 2010

(30) Foreign Application Priority Data
Aug. 7, 2007 (FR) 0756978

(51) Int. Cl. B29C 49/04

(52) U.S. Cl. 264/540; 425/549

(57) ABSTRACT

A process for manufacturing a plastic hollow body by molding a molten plastic parison, which is extruded vertically through a die, in a mold comprising two complementary cavities, characterized in that the die is adjusted so that the shape of the parison matches that of the mold cavities. A die suitable for such a process.

### CROSS-REFERENCE TO RELATED APPLICATIONS

This application is a U.S. national stage application under 35 U.S.C. §371 of International Application No. PCT/EP2008/060391 filed Aug. 7, 2008, which claims priority to French Patent Application No. 0756978 filed Aug. 7, 2007, these applications being incorporated herein by reference in their entirety for all purposes.

### TECHNICAL FIELD OF THE INVENTION

The present invention relates to a process for manufacturing a plastic hollow body, and in particular a fuel tank, from a parison that is extruded through a die. It also relates to a die for extruding a parison suitable for said process.

### BACKGROUND OF THE INVENTION

Fuel tanks (FTs) on board vehicles of various types are increasingly being based on plastics. These have, compared to metals, the advantage of lower weight and greater ease of molding. In general, plastic FTs are molded by the blow molding or thermoforming of sheets or of a parison extruded vertically through a die, which may or may not be located just above the mold.

These tanks generally include devices for supplying the engine with fuel. Such devices form the link between elements contained in the tank (valves, fuel pump, etc.) and elements positioned outside the tank (canister, fill pipe, etc.). Penetration through the wall of the tank must take into account the low permeability requirements laid down by current environmental standards (LEV II and PZEV for example). For this purpose, the reduction in the number and size of the openings in the wall of the tank constitutes a favorable factor in reducing evaporative losses. However, this makes it more difficult to insert components into the tank and position them therein.

Hence, Application EP 1110697 in the name of the Applicant discloses a process for molding a fuel tank using a parison made in several parts so as to be able to insert the accessories into the tank while it is being molded. For this purpose, a tubular parison is extruded, then, on exiting the die, two longitudinal cuts are made in it, along two opposed generatrices. That document recommends the use of a device for guiding, flattening and separating the two parison parts thus obtained, with a view to being able to introduce accessories into the tank at the same time as it is being molded.

Utility Model DE 20 2006 013 751 U1 proposes a die which makes it possible to directly cut, within the die, the cylindrical parison exiting the extruder and convert it into two flat parison parts. Such a process has the advantage of no longer requiring the parison to be subsequently flattened by separate handling tools which are expensive and complicate the process while impairing its safety (hot and moving electric tools).

However, an inherent problem of the molding processes of the prior art is linked to the fact that the parison (whether it is in one piece or in the form of two flat parts) must be clamped between the mold cavities and that the part that sticks out (at least at the top and at the bottom, or even around the entire periphery) is removed in the form of waste (known as scrap or flash in the jargon of the field) which may constitute a considerable weight fraction of the parison. For example, in the case where the mold cavities have a lower edge which is not horizontal and/or straight, the amount of scrap varies from one place to another on the parison. Moreover, following sagging of the molten plastic, the width of the parison generally varies over its length, generally leading to the formation of a restriction that gives rise to “wedges” of lost material.

Processes/equipment for varying the diameter of a tubular parison are known in the prior art. However, in these processes/equipment, the device/means that makes it possible to adapt this diameter is a device located outside of the die and not integrated into the die and therefore through which the stream of material is extruded. Therefore, the variations in diameter obtained are limited and do not generally make it possible to obtain a parison having a shape such that it matches the shape of the mold cavities (and therefore, of the tank to be molded) in order to reduce the amount of scrap.

### SUMMARY OF THE INVENTION

The object of the invention is therefore to provide a process which makes it possible to optimize the amount of scrap and which is based on the idea of adjusting the die, i.e. of modifying the width or the diameter of its outlet cross section as a function of time and/or of locally modifying the temperature of the material at the die exit (so that the parison is longer in some places (where the temperature is hotter) and shorter in other places so as to match the shape of the lower profile of the part to be molded). In other words: the shape (width and/or length in the case of parisons in the form of sheets; diameter and/or length in the case of tubular parisons) of the parison is adapted to that of the mold cavities.

For this purpose, the invention relates to a process for manufacturing a plastic hollow body by molding a molten plastic parison, which is extruded vertically through a die, in a mold comprising two complementary cavities, characterized in that the die is adjusted so that the shape of the parison matches that of the mold cavities.

It relates, in particular, to a process for manufacturing a plastic hollow body by molding a molten plastic parison, which is extruded vertically through a die, in a mold comprising two complementary cavities, in which the parison is cut longitudinally in the die by means of flow dividers that extend to the exit of the die and that have a position and shape suitable for helping, with the shape of the passage through the die, to convert the parison into two substantially flat sheets, characterized in that the die is adjusted so that the length of the sheets is varied locally by locally varying the temperature of the die and/or in that the width of the sheets is varied at the die exit as a function of time using moving parts that are attached to said die.

### DETAILED DESCRIPTION OF THE PREFERRED EMBODIMENTS

The process according to the invention is suitable for any hollow body and, in particular, for any hollow body on the inside of which it is desired to introduce at least one accessory. It advantageously applies to the manufacture of fuel tanks. The expression “fuel tank” is understood to mean an impermeable tank, able to store fuel under diverse and varied usage and enviromnental conditions. An example of this tank is that with which motor vehicles are fitted. In the remainder of the document, the expressions “hollow body” and “tank” should hence be considered to be equivalent.

The hollow body obtained by the process according to the invention is made with a plastic wall, generally comprising an internal face on its concave portion and an external face on its convex portion.

The term “plastic” is understood to mean any material comprising at least one synthetic resin polymer.

Any type of plastic may be suitable. Particularly suitable plastics belong to the category of thermoplastics.

The term “thermoplastic” is understood to mean any thermoplastic polymer, including thermoplastic elastomers, and also blends thereof. The term “polymer” is understood to mean both homopolymers and copolymers (especially binary or ternary copolymers). Examples of such copolymers are, in a non-limiting manner, random copolymers, linear block copolymers, other block copolymers, and graft copolymers.

Any type of thermoplastic polymer or copolymer, the melting point of which is below the decomposition temperature, is suitable. Synthetic thermoplastics having a melting range spread over at least 10 degrees Celsius are particularly suitable. Examples of such materials include those that exhibit polydispersion in their molecular weight.

In particular, it is possible to use polyolefins, thermoplastic polyesters, polyketones, polyamides and copolymers thereof. A blend of polymers or copolymers may also be used, similarly it is also possible to use a blend of polymeric materials with inorganic, organic and/or natural fillers such as, for example but in a non-limiting manner: carbon, salts and other inorganic derivatives, natural or polymeric fibers. It is also possible to use multilayer structures composed of stacked and joined layers comprising at least one of the polymers or copolymers described above.

One polymer often used for fuel tanks is polyethylene. Excellent results have been obtained with high-density polyethylene (HDPE).

Preferably, the hollow body for which the process according to the invention is intended has a multilayer structure comprising at least one layer of a thermoplastic and at least one additional layer which, advantageously, may consist of a material that is a barrier to liquids and/or gases.

Preferably, the nature and the thickness of the barrier layer are chosen so as to minimize the permeability of the liquids and gases in contact with the wall of the hollow body. Preferably, in the case of a fuel tank, this layer is based on a barrier material, i.e. on a fuel-impermeable resin such as, for example, EVOH (a partially hydrolyzed ethylene/vinyl acetate copolymer). Alternatively, the tank may be subjected to a surface treatment (fluorination or sulfonation) for the purpose of making it impermeable to the fuel.

The invention particularly applies to multilayer FTs molded from a parison comprising outer layers based on HDPE and an inner layer based on EVOH.

The term “molded” is understood to mean shaped in a mold comprising two complementary cavities, i.e. two inner surfaces, the peripheries of which coincide, and which are intended for molding the outer surface of the tank.

The term “parison” is understood to mean an extruded preform of any shape, generally substantially cylindrical (or tubular) or in the form of sheet(s), which is intended to form the wall of the hollow body after molding, i.e. after an operation which consists in forming the parison, which is in the melt state, into the required shapes and dimensions using a mold in order to obtain a tank.

According to the invention, this parison is extruded, i.e. results from the melting and/or plasticization of the plastic in an extruder, then from the expulsion of this plastic through an extrusion head, which generally gives it a cylindrical shape. The expression “extrusion head” is understood to mean an assembly of metal blocks and a core comprising a passage for at least one stream of molten plastic exiting an extruder. Such an assembly generally comprises at least one block (or distributor) for distributing the material in the form of an annular stream, and in the case of a coextrusion head, it generally comprises at least one distributor per layer of material.

The distributor or distributors, where appropriate, have passing right through them an orifice of which the outlet end is generally substantially annular and which defines, with the core, an annular outlet flow area for the molten plastic. The stream of molten plastic which is fed by the extruder to the extrusion head is generally a cylindrical stream of pressurized plastic. In the case of a coextrusion head (intended for extruding multilayer structures), there are generally as many feed orifices as cylindrical streams of material.

According to the invention, the parison exiting the extrusion head is extruded through a die, i.e. a set of parts intended to give the parison its final shape, which may be cylindrical, flattened (oblong), or even in the form of two “sheets” which will have a restricted tendency to curve and will therefore be easier to handle (see above). As explained below, this die may be a part that is integrated into the extruder head or attached to it.

Preferably, the parison has an adjustable thickness (i.e. one that can be varied, in a controlled manner, longitudinally (along a generatrix) and/or transversely (over the same section)) using at least one known device such as a WDS (vertically displaceable core), a PWDS (deformable ring), an SFDR (machined core of variable profile or pin of variable shape) or a “die slide” (part inserted locally into the die: see U.S. Pat. No. 5,057,267 in the name of the Applicant), integrated into the die. With respect to molding a parison of constant thickness, this way of proceeding makes it possible to take into account the reduction in thickness that occurs during molding (and in particular, blow molding) at certain places in the parison, as a result of the non-constant strain rates of the material in the.

According to one preferred variant, (which is in particular explained in the aforementioned utility model, the content of which is for this purpose incorporated by reference in the present application), the parison is cut longitudinally in the extrusion die in order to automate the process as much as possible and facilitate the stopping/starting of production runs. In this variant, preferably, the parison is first cut using flow dividers integrated into the die and then the two cut portions of the parison are gradually flattened due to a gradual modification of the inner passage of the die through which the stream or streams of plastic of the parison flow.

According to the invention, the die is adjusted so that the shape of the parison matches that of the mold cavities. This is understood to mean that its width (or its diameter for a tubular parison) and/or its length can be varied so that the part which sticks out of the mold is substantially constant over the periphery of the cavities. In practice, one means of varying the length of the parison consists in varying its temperature locally (i.e. over its diameter or its width so as to cause a variable flow of material) and one means of varying the width of the parison consists in varying the width (for a sheet die intended for manufacturing sheets) or the diameter (for a round die intended for manufacturing tubular parisons) of the outlet cross section of the die as a function of time. These variants may, depending on the shape of the cavities, be used independently or in combination.

Thus, the temperature of the die may be adjusted so that the lower edge of the parison matches the shape of the lower edge of the cavities as best as possible when this lower edge is not horizontal and/or straight (i.e. when the part of the periphery of the cavities that is substantially parallel to the ground is not a straight and/or horizontal line). Hence, as explained above, this adjustment must ensure that the parison is longer in some places (where the temperature is hotter) and shorter in other places. In other words, it must make it possible to vary the temperature of the molten plastic over its periphery (in the case of a cylindrical parison) or over its width (in the case of a two-part parison) i.e. over a section taken through the die exit through a plane perpendicular to the extrusion direction.

Likewise, to overcome the sagging of the parison (which is often responsible for the presence of a restriction over its length) the width or diameter of the outlet cross section of the die can advantageously be adjusted as a function of time. One means that is particularly suitable for this purpose consists in providing the core and/or the mantle of the die, preferably at its outlet, with moving parts for adjusting the width or diameter of the stream of molten material. This aspect is explained in greater detail in the figures appended to the present document and in the text which relates thereto.

The optimization of the abovementioned temperature and/or width (diameter) adjustment is generally carried out by simulation and experimental validation.

Most particularly preferably, the die of the process according to the invention is also equipped with a device for transversely cutting the parison (or of the sheets) to obtain parison pieces (or discontinuous sheets) which may then be molded. This cutting operation may take place by relative movement between the core and the mantle of the die, so as to momentarily interrupt the flow of material and therefore to cut the parison. Alternatively, it is possible to position under the die (or optionally integrate into its lower surface), hooks or blades to carry out this cutting operation.

When sheets that are already cut and partially flattened are obtained at the die exit, their handling and their transfer to the mold are markedly easier than in the processes of the prior art. It is therefore possible to reduce the height required between the die exit and the mold cavities. This will reduce the dwell time of the extruded material in the ambient air and thus will increase the temperature of the sheets, which will facilitate the subsequent molding process, in particular when this comprises a step of attaching component(s) (accessory(ies)) to the inside of the parison, onto its inner face, before finally molding the hollow body. Such a fastening of components, which is advantageous within the scope of the present invention, is for example described in Applications WO 2006/008308, WO 2006/032672 and WO2007/000454 in the name of the Applicant, the content of which is for this purpose incorporated by reference in the present application.

The transfer of the parison to the mold may take place in any known manner. However, according to one preferred variant, the mold cavities are positioned underneath the die and the parison (sheets) is/are extruded continuously between the cavities of the mold that is then closed over said sheets just before they are cut transversely and molded.

However, in this variant, the free end of the parison (which hangs by gravity between the mold cavities) has a tendency to warp, in particular when the sheets have a variable thickness as recommended below. Therefore, according to one most particularly preferred variant, this end (or rather this pair of sheet ends) is guided by jaws or hooks (preferably made of metal that is cooled or coated with PTFE for example) that make it possible to flatten them and to prevent the formation of folds and/or by a device attached to the mold as described in a co-pending application in the name of the Applicant.

In the process according to the invention, the tank is preferably molded as a single part (in a single step, after which a one-piece tank is obtained, without recourse to an additional step of assembling separate shells) from a split parison or a parison in at least two parts, and this by welding the split or the two parts of the parison when the mold is closed. In particular, the tank is advantageously molded by:
blow-molding, i.e. by expanding the cut parison and pressing it against the mold cavities using a pressurized fluid (as described in Application EP 1110697, the content of which is for this purpose incorporated by reference in the present application);
thermoforming the parison, i.e. by pressing the latter against the mold cavities, for example by providing suction (creating a vacuum) behind said cavities.

Preferably, the tank is molded by blow molding, optionally by drawing a vacuum behind the mold cavities (in order to press the parison thereon when the mold is open). This is because thermoforming generally involves heating the mold to a temperature close to the processing temperature of the plastic in order to be able to achieve deep deformations (corners of the tank for example, where the parison is highly stretched). This results in cycle times that are longer than with blow-molding, in which this constraint does not exist.

The present invention also relates to a die intended to be mounted on an extruder delivering a stream of cylindrical molten plastic material, said die having, for this purpose, a passage for said stream, the cross section of which is either annular or flattened (or even in two sheets) at the exit (i.e. on the side where the stream of molten plastic exits the die). This passage is preferably delimited by two separate parts: on the one hand, by a central part or core, which is in direct contact with the inner surface of the parison, and on the other hand, by an outer part, or mantle, which is in direct contact with the outer surface of the parison.

It relates, in particular, to a die intended to be mounted on an extruder delivering a stream of cylindrical material, said die having a passage for said stream, the cross section of which is cylindrical at the inlet but flattened at the exit and which in order to do this comprises flow dividers that extend to the die exit and that have a position and shape suitable for helping, with the shape of the passage through the die, to convert the initially cylindrical parison into two substantially flat sheets, said die also being equipped with moving parts for varying the width of its outlet cross section as a function of time and/or with a device for varying the temperature of the molten plastic locally at its exit.

Such a die has the advantage of being easily mountable on (and demountable from) a conventional extrusion head.

In this regard, it should be noted that it could also be used instead of such an extrusion head or, in other words that, within the context of the invention, the die could be integrated into the extrusion head as defined above.

According to the invention, this die is equipped with a device for varying the width or diameter of the parison as a function of time and/or with a device for varying the temperature of the molten plastic locally at its exit, i.e. over a section taken through the die exit by a plane perpendicular to the extrusion direction.

According to one preferred variant, this die comprises at least one flow divider which interrupts the passage for the molten material at a given place, preferably just at the die exit. This flow divider is therefore capable of splitting the cylindrical stream so as to obtain a split parison. Most preferably, the die according to this aspect of the invention comprises two flow dividers positioned in a diametrically opposed manner in the passage, so as to separate the parison into two parts along two opposed generatrices.

Most preferably, and as mentioned previously, the die according to the invention preferably also comprises a device for adjusting the thickness of the parison and/or a device for transversely cutting the parison.

As regards the device for adjusting the thickness of the parison, it is preferably a “die slide” (a part inserted locally into the die) as described in U.S. Pat. No. 5,057,267 in the name of the Applicant and the content of which is for this purpose incorporated by reference in the present application.

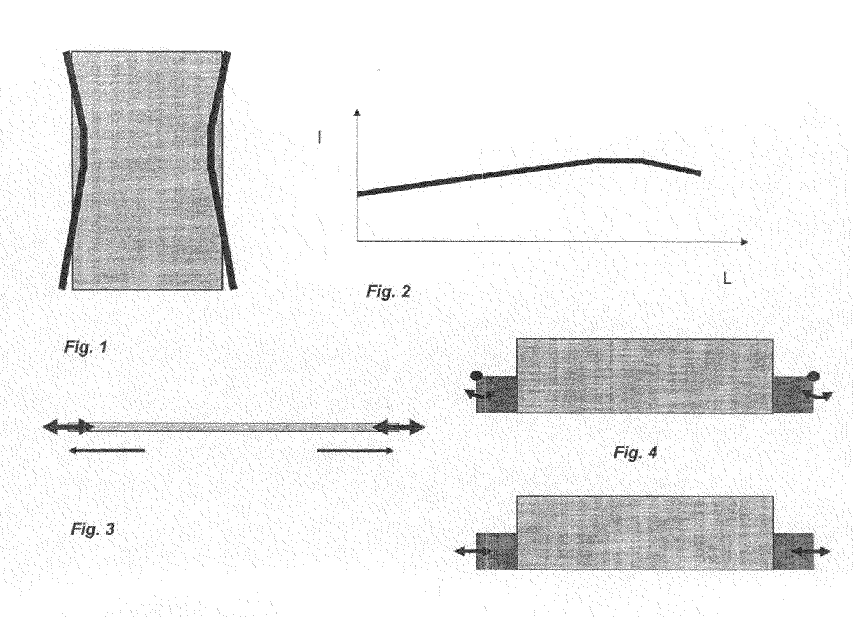

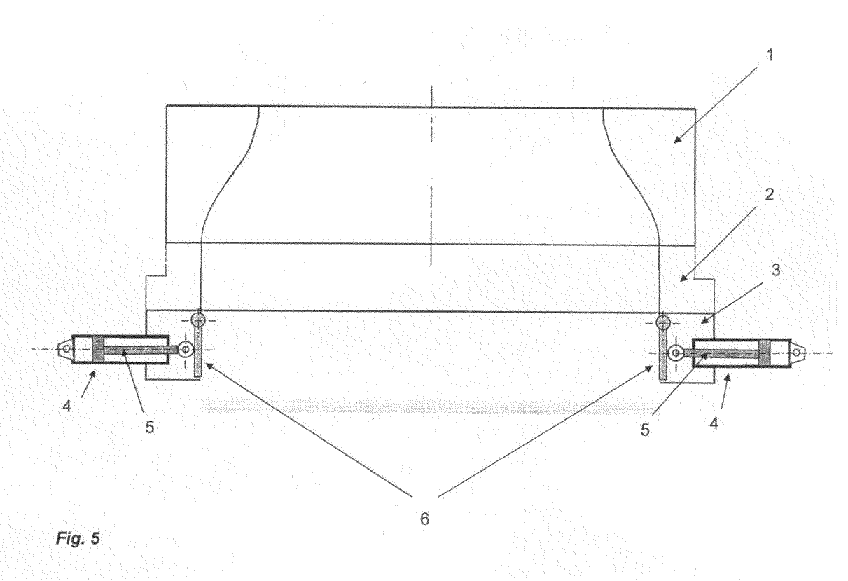

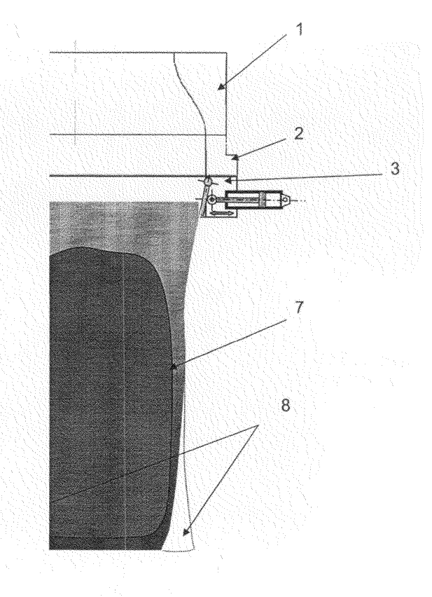

FIGS. 1 to 3 illustrate the invention in a theoretical manner; FIG. 4 schematically illustrates a 1^{st} variant of the invention and FIGS. 5 and 6, a 2^{nd} variant.

In particular, FIG. 1 illustrates, in bold lines, the actual shape of an extruded parison (sheet) and, in fine lines, the ideal shape that it should have in order to mold a substantially cylindrical article. It can be seen on this figure how the sagging of the material (which exits an extruder located upstream, which is not represented and from which the parison hangs by gravity) causes necking to occur.

FIG. 2 illustrates, in theory, the solution to this problem, which consists in varying the width (l) of the parison over the length (L), i.e. as a function of time in fact (considering that its length increases as the parison is extruded).

FIG. 3 schematically illustrates the manner of putting the solution into practice, which consists in varying the width of the sheet during its extrusion so as to compensate for the sagging.

FIG. 4 explicits this idea by illustrating blocks which can be moved either by pivoting or by translation and which are sometimes in the stream of molten material and sometimes partially or even completely retracted so as to vary the width of the sheet.

The device (4) illustrated in FIG. 5 (at rest) and FIG. 6 (in action) is mounted on a die comprising three zones: a zone (1) in which an initially cylindrical parison is converted into two sheets; a pressure-control zone (2) and a thickness-control zone (3). It is on the latter (3) that the device (4) is mounted, this device comprising a sliding rod (5), one end of which acts on a pivoting member (6) which has the effect of locally reducing the width of the sheets (shaded area) when they are activated (see FIG. 6).

The shape of the mold cavity (7) is illustrated in FIG. 6 where it can be seen that, by varying the lateral profile of the sheets, it is possible to achieve a considerable saving in material (8).

1. A process for manufacturing a plastic hollow body by molding a molten plastic parison, which is extruded vertically through a die, in a mold comprising two complementary cavities, wherein the die is adjusted so that the shape of the parison matches that of the mold cavities.

2. The process according to claim 1, wherein the length of the parison is varied locally by locally varying the temperature of the die and/or wherein the width or diameter of the parison are varied at the die exit as a function of time.

3. The process according to claim 1, wherein the thickness of the parison is adjusted using a device integrated into the die.

4. The process according to claim 1, wherein the longitudinal cutting of the parison is carried out in the die by means of flow dividers that extend to the exit of the die and that have a position and shape suitable for helping, with the shape of the passage through the die, to convert the parison into two substantially flat sheets.

5. The process according to claim 1, wherein the die comprises a core and a mantle, and wherein the parison is cut transversely by a relative movement between the core and the mantle of the die, so as to momentarily interrupt the flow of material.

6. The process according to claim 1, wherein the mold cavities are positioned underneath the die; and wherein the parison is extruded continuously between the cavities of the mold, that is then closed just before transversely cutting the parison and molding it.

7. The process according to claim 6, wherein the parison comprises a lower end which hangs by gravity between the mold cavities, and wherein said parison lower end is guided and flattened by a suitable device.

8. The process according to claim 1, wherein moulding wherein molding of the tank takes place by blow molding, optionally by drawing a vacuum behind the mold cavities.

9. The process according to claim 1, using an insert having a shape and size that are suitable for being able to be partly inserted between the cavities of the mold when the mold is closed.

10. A die suitable for the process according to claim 1, which is intended to be mounted on an extruder delivering a stream of cylindrical molten plastic material, said die having, for this purpose, a passage for said stream, the cross section of which is annular or flattened or in form of two sheets at the exit (i.e. on the side where the stream of molten plastic exits the die) and which is equipped with a device for varying the diameter or the width of its outlet cross section as a function of time and/or the temperature of the molten plastic locally at its exit (i.e. over a section taken through the die exit by a plane perpendicular to the extrusion direction).
